(19) United States
(12) Patent Application Publication
(10) Pub. No.: US 2015/0085466 A1
(43) Pub. Date: Mar. 26, 2015

(54) LOW PROFILE LED-BASED LIGHTING ARRANGEMENTS

(71) Applicant: Intematix Corporation, Fremont, CA (US)

(72) Inventor: Charles Edwards, Pleasanton, CA (US)

(73) Assignee: Intematix Corporation, Fremont, CA (US)

(21) Appl. No.: 14/495,837

(22) Filed: Sep. 24, 2014

Related U.S. Application Data
(60) Provisional application No. 61/881,886, filed on Sep. 24, 2013.

(51) Int. Cl. F21K 99/00

(52) U.S. Cl. CPC F21K 9/56; F21Y 2101/02
USPC 362/84

(57) ABSTRACT

Disclosed are LED-based lighting arrangements that include an integrated lighting component that includes both a photoluminescence wavelength conversion portion and a diffusing portion. The integrated lighting component can be used to implement low-profile lighting arrangements having very small installation space requirements.

### CROSS-REFERENCE TO RELATED APPLICATIONS

This present application claims the benefit of priority to U.S. Provisional Application No. 61/881,886, filed on Sep. 24, 2013, which is hereby incorporated by reference in its entirety.

### BACKGROUND

This invention relates to LED-based lighting arrangements that utilize a remote photoluminescence wavelength conversion component to generate a desired color of light. In particular, although not exclusively, embodiments of the invention concern low profile LED lighting arrangements such as for example down lights or under cabinet lamps.

White light emitting LEDs (“white LEDs”) are known and are a relatively recent innovation. It was not until LEDs emitting in the blue/ultraviolet part of the electromagnetic spectrum were developed that it became practical to develop white light sources based on LEDs. As taught, for example in U.S. Pat. No. 5,998,925, white LEDs include one or more one or more photoluminescent materials (e.g., phosphor materials), which absorb a portion of the radiation emitted by the LED and re-emit light of a different color (wavelength). Typically, the LED chip or die generates blue light and the phosphor(s) absorbs a percentage of the blue light and re-emits yellow light or a combination of green and red light, green and yellow light, green and orange or yellow and red light. The portion of the blue light generated by the LED that is not absorbed by the phosphor material combined with the light emitted by the phosphor provides light which appears to the eye as being nearly white in color. Alternatively, the LED chip or die may generate ultraviolet (UV) light, in which phosphor(s) to absorb the UV light to re-emit a combination of different colors of photoluminescent light that appear white to the human eye.

Due to their long operating life expectancy (>50,000 hours) and high luminous efficacy (70 lumens per watt and higher) high brightness white LEDs are increasingly being used to replace conventional fluorescent, compact fluorescent and incandescent light sources.

Typically the phosphor material is mixed with light transmissive materials, such as silicone or epoxy material, and the mixture applied to the light emitting surface of the LED die. It is also known to provide the phosphor material as a layer on, or incorporate the phosphor material within, an optical component, a phosphor wavelength conversion component, that is located remotely to the LED die (“remote phosphor” LED devices).

There are many types of lighting devices in modern lighting applications for which it may be desired to implement as LED-based lights. One type of lighting device is a downlight, which is often also referred to as a recessed light, pot light, or canister light. These lighting devices are implemented as light fixtures which are often installed into a ceiling and emit light in a downwards direction.

There are generally two main parts to conventional downlights, which include the housing and the trim. The housing is the portion of the fixture that is installed inside the ceiling and which contains the electronics and lighting elements for the downlight. The trim is the surrounding portion of the light fixture which is visible around the central opening of the downlight.

The problem with conventional downlights is that, to have enough room to contain all of the necessary electronics, heat sink and lighting elements, the housing for the downlight must be designed to have a significantly large interior volume. As a result, the downlight housing must usually be formed as a relatively large cylindrical shape.

From an installation point of view, the design of the conventional downlight therefore often limits the usability of the light. Given the size of the housing in a conventional downlight, ceilings must have sufficient clearance in their interior heights to be able to fit the downlight housing. As a result, it is impossible to install downlights in rooms having zero or minimal interior ceiling spaces.

In addition, additional costs are often required to install downlights. This is because the size of the housing for conventional downlights requires relatively more work, effort, time, and expense to plan and cut large-enough holes to fit the downlight. Moreover, the size and weight of the downlight often necessitates sturdy mounting brackets to be installed to support the downlight.

These problems are further exacerbated when the downlight is implemented as an LED-based lighting device. This is because, to handle the amount of heat to be generated by the LED components in the light, the lighting housing must be sized even larger and heavier to include sufficient amounts of heat sinks and other heat dissipation components.

Therefore, it should be clear that there is a need for an improved approach to implement downlight fixtures.

### SUMMARY OF THE INVENTION

Embodiments of the invention concern LED-based lighting arrangements that include an integrated lighting component that includes both a photoluminescence wavelength conversion portion and a diffusing portion. The integrated lighting component can be used to implement low-profile lighting arrangements having very small installation space requirements.

### BRIEF DESCRIPTION OF THE DRAWINGS

In order that the present invention is better understood LED-based lighting arrangements and integrated photoluminescence wavelength conversion lighting components in accordance with the invention will now be described, by way of example only, with reference to the accompanying drawings in which like reference numerals are used to denote like parts, and in which:

FIGS. 1A to 1F respectively show: a perspective top view; a side view; a top view; a sectional side view through A-A; a bottom view; and an exploded perspective top view of an LED-based lamp in accordance with an embodiment of the invention;

FIG. 2 shows a perspective top view of a housing of the lamp of FIGS. 1A to 1F;

FIGS. 3A, 3B and 3C respectively show side, bottom and perspective bottom views of an integrated photoluminescence wavelength conversion lighting component in accordance with an embodiment of the invention;

FIGS. 3D and 3E respectively show a sectional and exploded sectional views through B-B of the integrated lighting component of FIGS. 3A to 3C;

FIGS. 4A and 4B respectively show perspective and exploded perspective views of an LED array for the lamp of the invention;

FIG. 5A is a sectional view of an integrated photoluminescence wavelength conversion component in accordance with an embodiment of the invention;

FIG. 5B is a sectional view of an integrated photoluminescence wavelength conversion lighting component in accordance with an embodiment of the invention;

FIGS. 6A and 6B respectively show a bottom view and a sectional view through C-C of an integrated photoluminescence wavelength conversion lighting component in accordance with an embodiment of the invention; and

FIGS. 7A and 7B respectively show a bottom view and a sectional view through D-D of an integrated photoluminescence wavelength conversion lighting component in accordance with an embodiment of the invention.

### DETAILED DESCRIPTION OF THE INVENTION

Embodiments of the invention concern LED-based lighting arrangements that include an integrated photoluminescence wavelength conversion lighting component that includes both a wavelength conversion portion and a diffusing portion. The integrated lighting component can be used to implement low-profile lighting arrangements having very small installation space requirements.

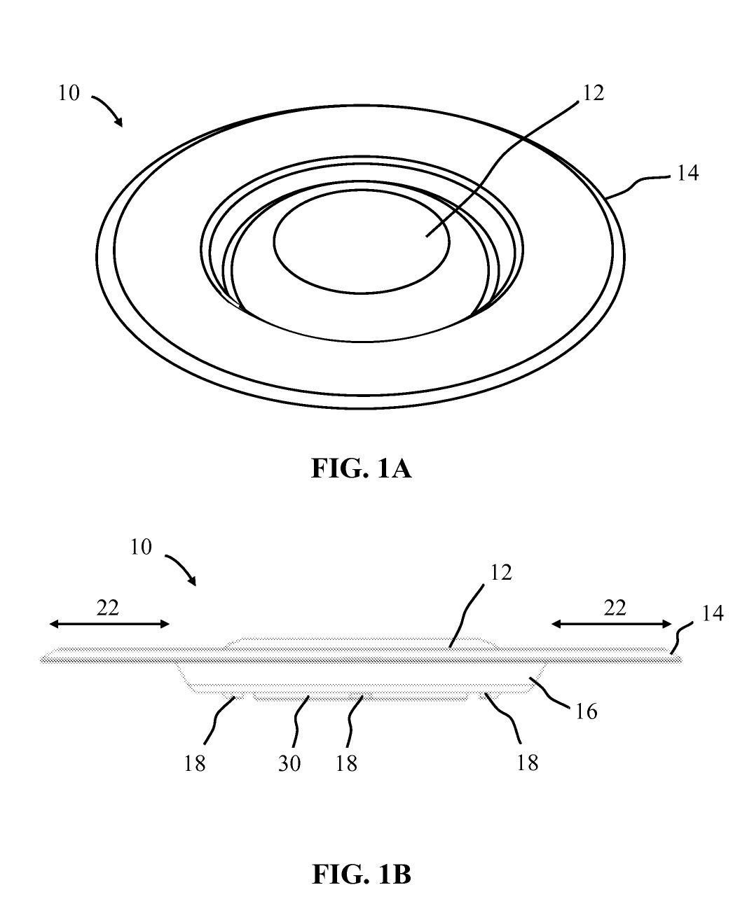

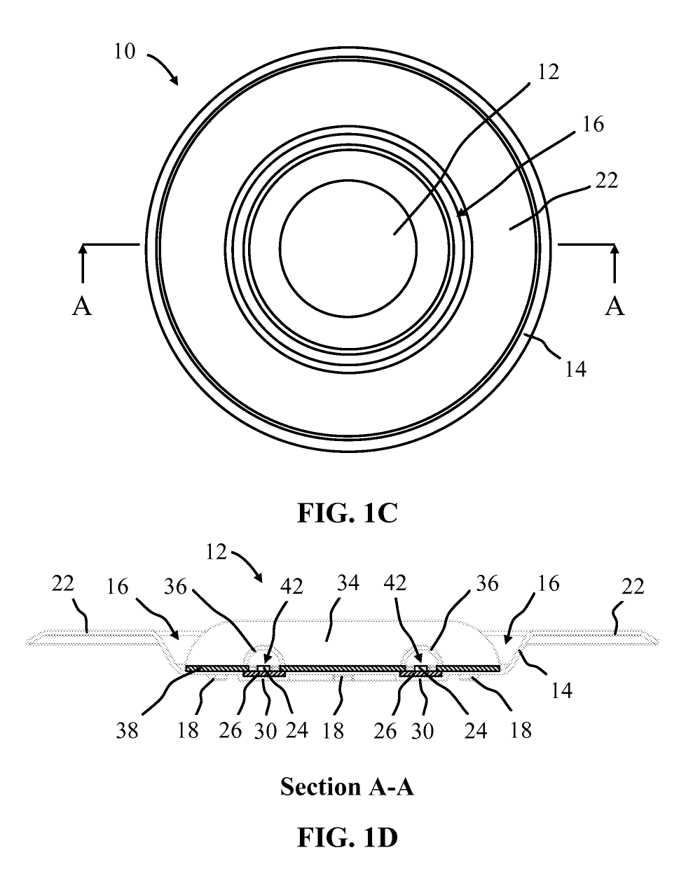

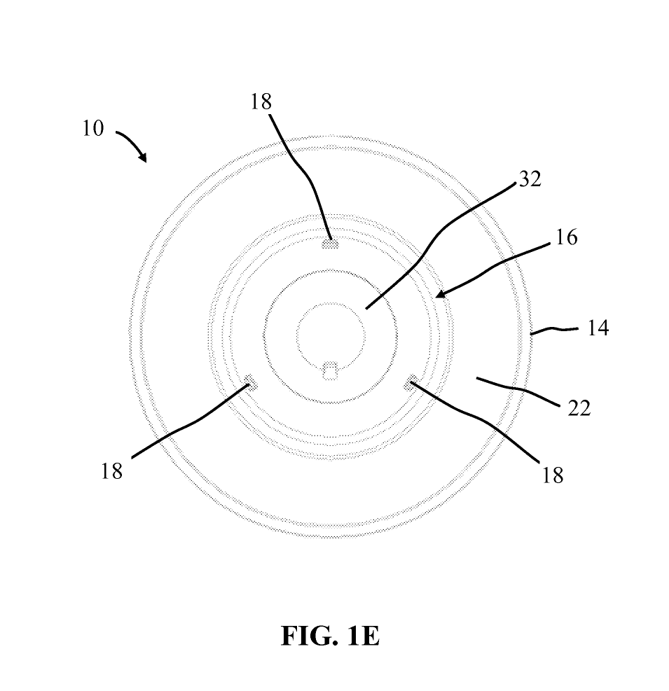

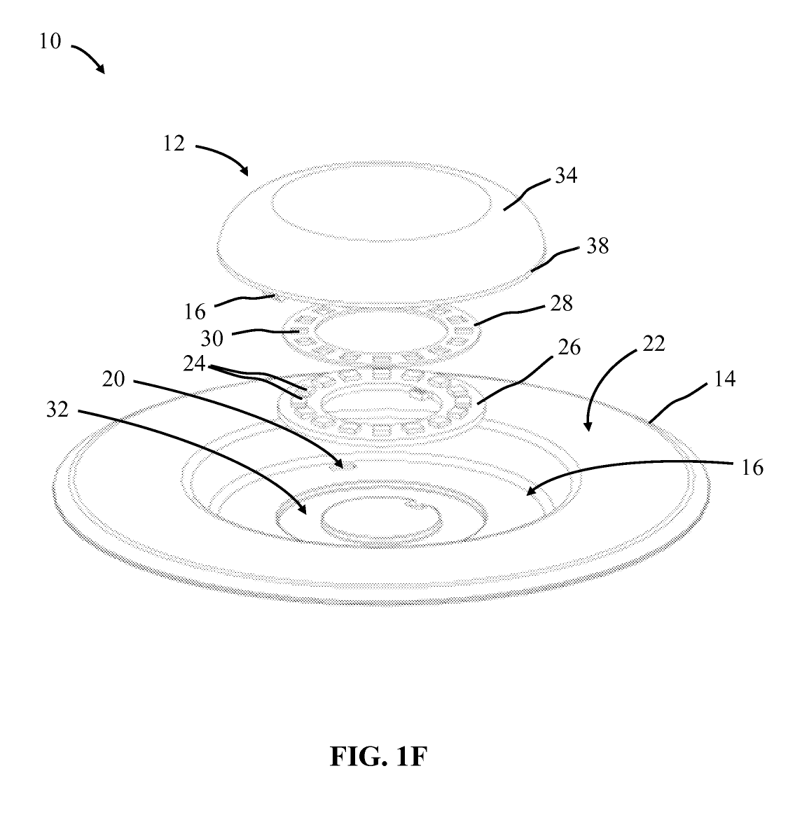

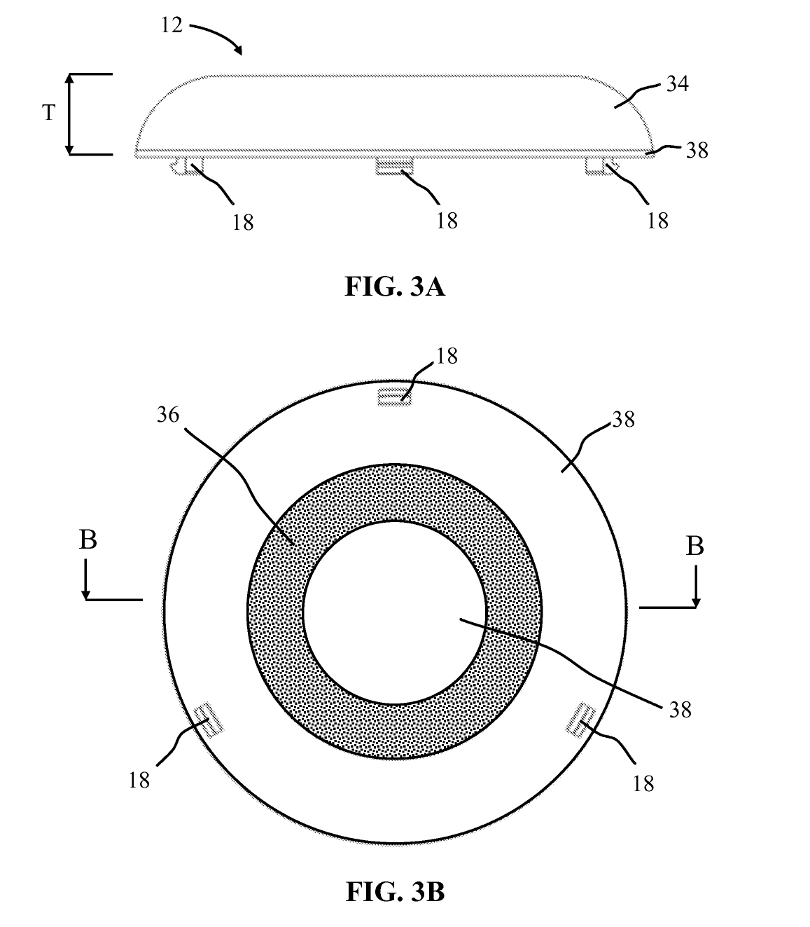

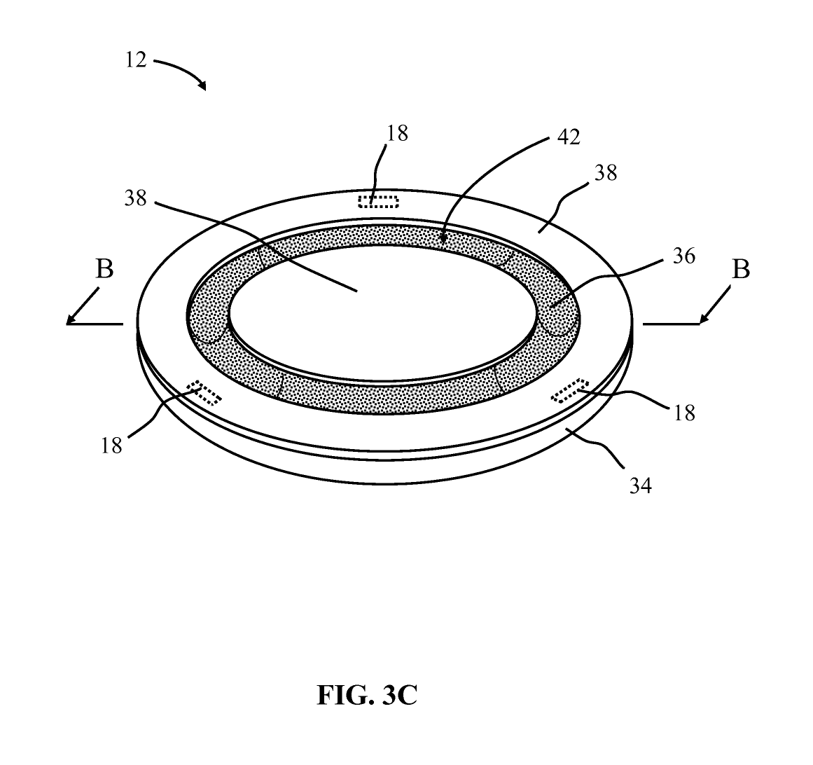

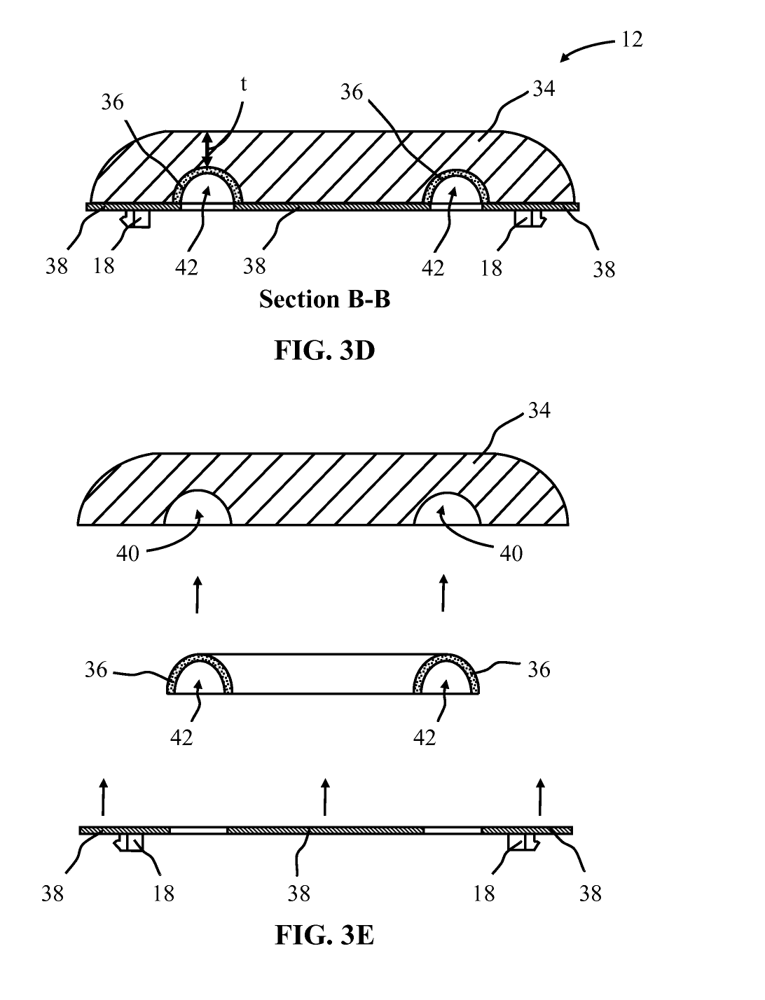

Referring to FIG. 1A there is shown a LED-based lighting arrangement (lamp) 10 for a downlight in accordance with an embodiment of the invention. The lighting arrangement 10 is for generating light of a selected color and/or color temperature, such as for example, white light. The lighting arrangement 10 includes an integrated photoluminescence wavelength conversion lighting component 12, hereinafter “integrated wavelength conversion component”, and a housing 14. As can be seen in the side view of FIG. 1B, the housing 14 comprises a low-profile structure having a very shallow depth. The interior of housing 14 includes a circular dish-shaped recess 16 having a generally planar bottom surface. The integrated wavelength conversion component 12 fits within the dished recess 16 on a top surface of the housing 14 (FIG. 1D). As shown in FIG. 3A, a set of clips/tabs 18 exists on the underside of the integrated wavelength conversion component 10, where the clips/tabs 18 extends through and resiliently engage with a set of corresponding apertures 20 (FIG. 1F) on the base of the dished shaped opening 16 to attach the integrated wavelength conversion component 12 to the housing 14.

The housing 14 further includes a bezel 22 that extends outwards in an annular arrangement from the upper portion of the housing 14. The 22 bezel may be integrally formed into the material of the housing 14. Alternatively, the bezel 22 may be implemented as a component that is separately manufactured from housing 14, but affixed to housing 14 as part of the overall lighting arrangement 10.

FIG. 1C is a top view of the lighting arrangement 10 and FIG. 1D is a sectional view at Section A-A. A plurality of LEDs 24 is placed in an annular array on the bottom surface of the dish shaped recess 16. The array of LED chips 24 can be implemented, for example, using Gallium Nitride-based chips, which are operable to produce light, radiation, preferably of wavelength in a range 300 to 500 nm, and more preferably to generate blue light with a dominant wavelength of 455 nm-465 nm. The LEDs 24 can be configured as an array, e.g., in an annular array and/or oriented such that their principle emission axis is parallel with the projection axis of the lamp.

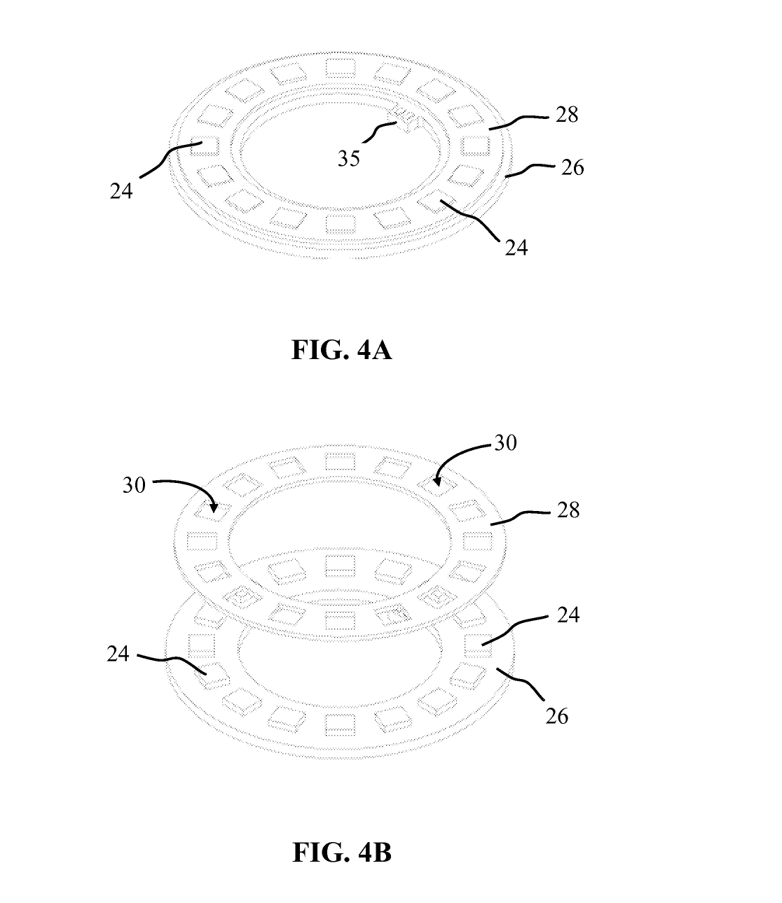

The LED chips 24 are mounted onto a substrate 26. In some embodiments, the substrate 26 comprises an annular MCPCB (Metal Core Printed Circuit Board). As is known, a MCPCB comprises a layered structure composed of a metal core base, typically aluminum, a thermally conducting/electrically insulating dielectric layer and a copper circuit layer for electrically connecting electrical components in a desired circuit configuration. The metal core base of the MCPCB 26 is mounted in thermal communication with the floor of the recess 16, e.g., with the aid of a thermally conducting compound such as for example a material containing a standard heat sink compound containing beryllium oxide or aluminum nitride. As shown in FIGS. 4A and 4B, a light reflective annular mask 28 can be provided overlaying the MCPCB that includes apertures 30 corresponding to each LED 24 to maximize light emission from the lighting arrangement.

FIG. 1F shows an exploded perspective top view of the LED lighting arrangement 10, showing the order and configuration of components within the arrangement. The housing 14 includes a central depressed portion 16 with a toroidal/annular indentation 32 matching the shape of the circuit board 26. The indentation 32 is configured such that when the circuit board is mounted within the indentation the top surface of the circuit board is flush with the floor of the depressed region 16. The light reflective mask 28 is fitted over the circuit board 26, where apertures 30 in the mask 28 are configured to allow each LED 24 to extend through a respective aperture 30. The integrated wavelength conversion component 12 is also placed within the central recess 16 within the housing 14 and attached thereto by means of the tabs 18.

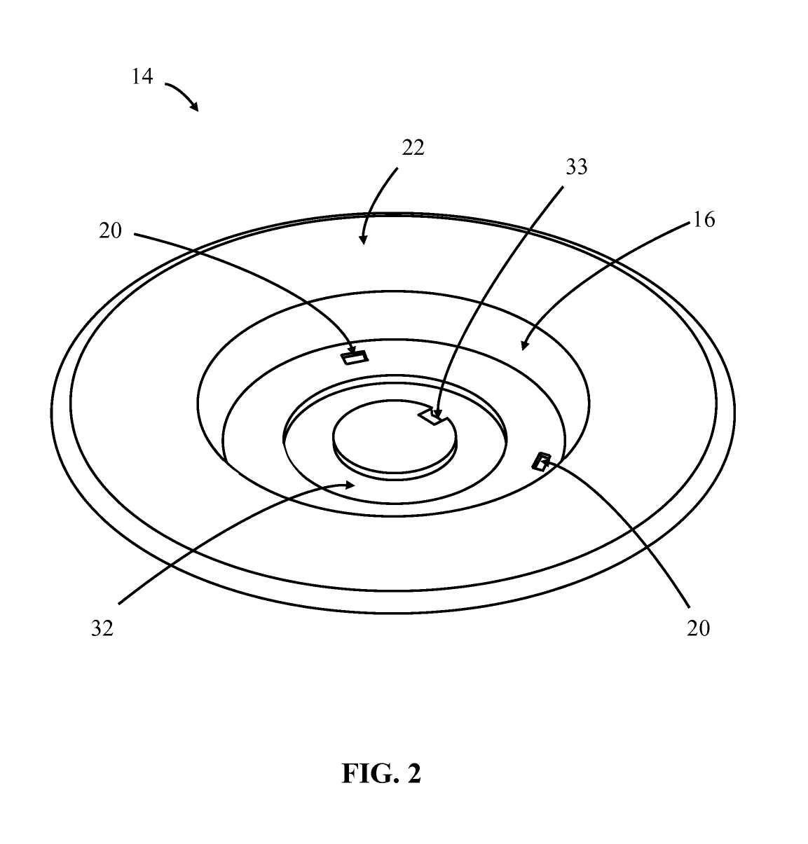

A power supply housing (not shown) may be included to hold power electronics for the lamp 10. The power supply housing could be located, for example, on the underside of housing 14 below clips 18. Wiring from the power electronics in the power supply housing is routed to the terminal 35 on the MCPCB 26 (FIG. 4A) using the through-hole 33 on the housing 14 (as shown in FIG. 2).

FIGS. 3A to 3D are illustrations that show greater details regarding the integrated wavelength conversion component 12. The integrated wavelength conversion component 12 comprises a light diffusive upper portion 34, at least one wavelength conversion portion 36 including a photoluminescence material and optionally a light reflective base 38. The base 38 includes a set of clips/tabs 18 extending from its underside. The clips/tabs 18 extends through a set of corresponding apertures 20 on the bottom of the recess 16 to attach the integrated wavelength conversion component 12 to the housing 14.

In one embodiment, the light diffusive top portion 34 of the integrated wavelength conversion component 12 is integrally formed with the base 38, e.g., where the integrated wavelength conversion component 12 is entirely formed of a plastics or polymer material. In an alternate embodiment, the light diffusive top portion 34 of the integrated wavelength conversion component 12 is separately formed from the base 38, e.g., where it is desired to have the top portion 34 possess a different material from the base 38. For example, the top portion 34 can be manufactured from a silicone material, while the base portion is formed using a more structurally stiff plastics or polymer material. This approach permits the top portion 34 to possess a “soft” feel to the human touch, while still allowing tabs 18 on base 38 to be rigid enough to supportively and affirmatively clip to housing 14.

The bottom surface of the integrated wavelength conversion component 12 comprises a toroidal indentation 42 (FIG. 3C and 3D) having a profile that matches the arrangement of the plurality of LEDs 24. As indicated the indentation 42 has a profile that is substantially semicircular such that the indentation is toroidal in form comprises a half torus. Provided in the indentation 42 within the integrated wavelength conversion component 12 is a layer of photoluminescence material 36.

In some embodiments, the photoluminescence materials comprise phosphor materials. For the purposes of illustration only, the following description is made with reference to photoluminescence materials embodied specifically as phosphor materials. However, the invention is applicable to any type of photoluminescence material, such as either phosphor materials or quantum dots. A quantum dot is a portion of matter (e.g. semiconductor) whose excitons are confined in all three spatial dimensions that may be excited by radiation energy to emit light of a particular wavelength or range of wavelengths.

The one or more phosphor materials can include an inorganic or organic phosphor such as for example silicate-based phosphors, aluminate-based phosphors, aluminate-silicate phosphors, nitride phosphors, sulfate phosphor, oxy-nitrides and oxy-sulfate phosphors or garnet materials (YAG). Examples of silicate-based phosphors are disclosed in United States patents U.S. Pat. No. 7,575,697 B2 “Silicate-based green phosphors”, U.S. Pat. No. 7,601,276 B2 “Two phase silicate-based yellow phosphors”, U.S. Pat. No. 7,655,156 B2 “Silicate-based orange phosphors” and U.S. Pat. No. 7,311,858 B2 “Silicate-based yellow-green phosphors”. Examples of aluminate materials are disclosed in United States patents U.S. Pat. No. 7,541,728 B2 “Novel aluminate-based green phosphors” and U.S. Pat. No. 7,390,437 B2 “Aluminate-based blue phosphors”. An example of an aluminate-silicate phosphor is disclosed in United States patent U.S. Pat. No. 7,648,650 B2 “Aluminum-silicate orange-red phosphor”. Examples of nitride-based red or green phosphor materials include those disclosed in co-pending United States patent applications: US 2012/0043503 A1 “Europium-Activated, Beta-SiAlON Based Green Phosphors”, US2009/0283721 A1 “Nitride-based red phosphors”, US2013-0234589 “Red-Emitting Nitride-Based Phosphors”, US 2013/0168605 A1 “Nitride Phosphors with Interstitial Cations for Charge Balance” and United States patent U.S. Pat. No. 8,274,209 B2 “Nitride-based red-emitting in RGB (red-green-blue) lighting systems”. The entire content of each of the afore-referenced applications and patents is incorporated herein by way of reference thereto. It will be appreciated that the phosphor material is not limited to the examples described and can include any phosphor material as known in the art.

Quantum dots can comprise different materials, for example cadmium selenide (CdSe). The color of light generated by a quantum dot is enabled by the quantum confinement effect associated with the nano-crystal structure of the quantum dots. The energy level of each quantum dot relates directly to the size of the quantum dot. For example, the larger quantum dots, such as red quantum dots, can absorb and emit photons having a relatively lower energy (i.e. a relatively longer wavelength). On the other hand, orange quantum dots, which are smaller in size can absorb and emit photons of a relatively higher energy (shorter wavelength). Additionally, daylight panels are envisioned that use cadmium-free quantum dots and rare earth (RE) doped oxide colloidal phosphor nano-particles, in order to avoid the toxicity of the cadmium in the quantum dots.

Examples of suitable quantum dots include: CdZnSeS (cadmium zinc selenium sulfide), CdₓZn₁₋ₓ Se (cadmium zinc selenide), CdSeₓS₁₋ₓ (cadmim selenium sulfide), CdTe (cadmium telluride), CdTeₓS₁₋ₓ (cadmium tellurium sulfide), InP (indium phosphide), InₓGa₁₋ₓ P (indium gallium phosphide), InAs (indium arsenide), CuInS₂ (copper indium sulfide), CuInSe₂ (copper indium selenide), CuInSₓSe₂₋ₓ (copper indium sulfur selenide), Cu InₓGa₁₋ₓS₂ (copper indium gallium sulfide), CuInₓGa₁₋ₓSe₂ (copper indium gallium selenide), CuInₓAl₁₋ₓ Se₂ (copper indium aluminum selenide), CuGaS₂ (copper gallium sulfide) and CuInS₂ₓZnS₁₋ₓ (copper indium selenium zinc selenide).

The quantum dots material can comprise core/shell nano-crystals containing different materials in an onion-like structure. For example, the above described exemplary materials can be used as the core materials for the core/shell nano-crystals. The optical properties of the core nano-crystals in one material can be altered by growing an epitaxial-type shell of another material. Depending on the requirements, the core/shell nano-crystals can have a single shell or multiple shells. The shell materials can be chosen based on the band gap engineering. For example, the shell materials can have a band gap larger than the core materials so that the shell of the nano-crystals can separate the surface of the optically active core from its surrounding medium. In the case of the cadmiun-based quantum dots, e.g. CdSe quantum dots, the core/shell quantum dots can be synthesized using the formula of CdSe/ZnS, CdSe/CdS, CdSe/ZnSe, CdSe/CdS/ZnS, or CdSe/ZnSe/ZnS. Similarly, for CuInS₂ quantum dots, the core/shell nanocrystals can be synthesized using the formula of CuInS₂/ZnS, CuInS₂/CdS, CuInS₂/CuGaS₂, CuInS₂/CuGaS₂/ZnS and so on.

In operation, the light emitted by the LEDs 24 is converted by the photoluminescence material 36 into photoluminescence light. The color quality of the final light emission output of the lighting arrangement is based (at least in part) upon the combination of the wavelength of the photoluminescence light emitted by the photoluminescence material 36 with the wavelength of any remaining, unconverted, light from the LEDs 24 that passes through the photoluminescence material 36. The color of light emitted from the lighting arrangement can be controlled by appropriate selection of the photoluminescence material composition as well as the thickness of the photoluminescence material layer which will determine the proportion of output light originating from the photoluminescence material.

The low-profile nature of LED lighting arrangement 10 solves the above-described problems inherent with conventional downlights. As discussed above, one problem with conventional downlights is that, to have enough room to contain all of the necessary electronics and lighting elements, the housing for the downlight must be designed to have a significantly large volume in its interior. As a result, the downlight housing must usually be formed as a relatively large cylindrical shape. This therefore limits the usability of the conventional downlight, in rooms having zero or minimal interior ceiling spaces. In contrast, the inventive embodiment of a downlight described herein provides a form factor having a very shallow depth. The inventive downright is therefore installable in almost any ceiling, even ceilings having the only minimal clearance spaces.

In addition, additional costs are often required to install conventional downlights, since extensively large holes must be planned and cut to fit the downlight. With the inventive downlight, only relatively small, shallow indentations are required to be formed to fit the small depth of housing to install the downlight.

Moreover, the size and weight of the downlight often necessitates sturdy mounting brackets to be installed to support the downlight. Here, the much smaller mass and size of the LED lighting arrangement 10 allows for much smaller brackets to be used to mount the LED lighting arrangement 10.

Conventional downlights can often require the presence of very large heat sinks and other heat dissipation components. The relative size and configuration of the housing 14 with its bezel 22 permits these structures to adequately function as the heat dissipation components for the LED lighting arrangement 10. In an alternate embodiment, additional heat sinks may also be included within the LED lighting arrangement 10.

Another advantage of the present approach is that the integrated wavelength conversion component 12 can be formed as the final stage optic for the lighting arrangement 10, which is directly visible to viewers of the light. This means that no additional lens or cover is needed to be manufactured and affixed over the arrangement to produce a final lighting product.

It is noted that the current embodiment functions as a remote phosphor lighting arrangement, whereby the photoluminescence (phosphor) material layer 36 is spaced apart from the LEDs 24. This arrangement also serves to assist in effecting more efficient thermal management for the LED lighting arrangement 10, since the heat generation is not concentrated at the circuit board 26, as would be the case if a phosphor encapsulated LED located at the circuit board is provided to generate light.

One problem associated with LED lighting device that is addressed by embodiments of the invention is the non-white color appearance of the device in an “OFF-state”. During an “ON-state”, the LED chip or die generates blue light and some portion of the blue light is thereafter absorbed by the phosphor(s) to re-emit yellow light (or a combination of green and red light, green and yellow light, green and orange or yellow and red light). The portion of the blue light generated by the LED that is not absorbed by the phosphor combined with the light emitted by the phosphor provides light which appears to the human eye as being nearly white in color. However, in an OFF-state, the LED chip or die does not generate any blue light. Instead, light that is produced by the remote phosphor lighting apparatus is based at least in part upon external light (e.g. sunlight or room lights) that excites the phosphor material in the wavelength conversion component, and which therefore generates a yellowish, yellow-orange or orange color in the photoluminescence light. Since the LED chip or die is not generating any blue light, this means that there will not be any residual blue light to combine with the yellow/orange light from the photoluminescence light of the wavelength conversion component (e.g. phosphor 36) to generate white appearing light. As a result, the lighting device will appear to be yellowish, yellow-orange or orange in color. This may be undesirable to the potential purchaser or customer that is seeking a white-appearing light.

According to some embodiments, a light diffusing material can be distributed within the material of upper portion 34 the integrated wavelength conversion component 12, providing the benefit of improving the visual appearance of the device in an OFF-state to an observer. In part, this is because the light diffusing material can substantially reduce the passage of external excitation light that would otherwise cause the wavelength conversion component to re-emit light of a wavelength having a yellowish/orange color. The particles of a light diffractive material are selected, for example, to have a size range that increases its probability of scattering blue light, which means that less of the external blue light passes through the light diffusing layer to excite the wavelength conversion layer. Therefore, the remote phosphor lighting apparatus will have more of a white appearance in an OFF-state since the wavelength conversion component is emitting less yellow/red light.

The light diffractive particle size can be selected such that the particles will scatter blue light relatively more (e.g. at least twice as much) as they will scatter light generated by the phosphor material. Such a light diffusing materials ensures that during an OFF-state, a higher proportion of the external blue light received by the device will be scattered and directed by the light diffractive material away from the wavelength conversion layer 36, decreasing the probability of externally originated photons interacting with a phosphor material particle and minimizing the generation of the yellowish/orange photoluminescent light. However, during an ON-state, phosphor generated light caused by excitation light from the LED light source can nevertheless pass through the diffusing material layer with a lower probability of being scattered. Preferably, to enhance the white appearance of the lighting device in an OFF-state, the light diffractive material within the light diffusing layer is a “nano-particle” having an average particle size of less than about 150 nm. For light sources that emit lights having other colors, the nano-particle may correspond to other average sizes. For example, the light diffractive material within the light diffusing layer for an UV light source may have an average particle size of less than about 100 nm.

Therefore, by appropriate selection of the average particle size of the light scattering material, it is possible to configure the lamp such that it scatters excitation light (e.g. blue light) more readily than other colors, namely green and red as emitted by the photoluminescence materials. For example, TiO₂ particles with an average particle size of 100 nm to 150 nm are more than twice as likely to scatter blue light (450 nm to 480 nm) than they will scatter green light (510 nm to 550 nm) or red light (630 nm to 740 nm). As another example, TiO₂ particles with an average particle size of 100 nm will scatter blue light nearly three times (2.9=0.97/0.33) more than it will scatter green or red light. For TiO₂ particles with an average particle size of 200 nm these will scatter blue light over twice (2.3=1.6/0.7) as much as they will scatter green or red light. In accordance with some embodiments of the invention, the light diffractive particle size is preferably selected such that the particles will scatter blue light relatively at least twice as much as light generated by the phosphor material(s).

Another problem with remote phosphor devices that can be addressed by embodiments of the invention is the variation in color of emitted light with emission angle. This problem is commonly called COA (Color Over Angle). Remote phosphor layers allow a certain amount of blue light to escape as the blue component of white light. This is directional light coming from the LEDs. The RGY (Red Green Yellow) light coming from the phosphor is lambertian. Therefore the directionality of the blue light may be different than that of the RGY light causing a “halo” effect at the edges with color looking “cooler” in the direction of the blue LED light and ^{“}warmer” at the edges where the light is all RGY. The addition of nano-diffuser selectively diffuses blue light—causing it to have the same lambertian pattern as the RGY light and creating a very uniform color over angle. Traditional LEDs also have this problem which can be improved by remote phosphor using this technology. Remote phosphor devices are often subject to perceptible non-uniformity in color when viewed from different angles. Embodiments of the invention correct for this problem, since the addition of a light diffusing layer in direct contact with the wavelength conversion layer significantly increases the uniformity of color of emitted light with emission angle θ.

Embodiments of the present invention can be used to reduce the amount of phosphor materials that is required to manufacture an LED lighting product, thereby reducing the cost of manufacturing such products given the relatively costly nature of the phosphor materials. In particular, the addition of a light diffusing material can substantially reduce the quantity of phosphor material required to generate a selected color of emitted light. This means that relatively less phosphor is required to manufacture a wavelength conversion component as compared to comparable prior art approaches. As a result, it will be much less costly to manufacture lighting apparatuses that employ such wavelength conversion components, particularly for remote phosphor lighting devices. In operation, the diffusing layer increases the probability that a photon will result in the generation of photoluminescence light by reflecting light back into the wavelength conversion layer. Therefore, inclusion of a diffusing layer with the wavelength conversion layer can reduce the quantity of phosphor material required to generate a given color emission product, e.g. by up to 40%.

Alternative approaches can be taken to improve the off-state white appearance of the lamp. For example, texturing can be incorporated into the exterior surface of the integrated component 10 to improve the off-state white appearance of the lamp.

Further details regarding an exemplary approach to implement scattering particles are described in U.S. patent application Ser. No. 11/185,550, filed on Oct. 13, 2011, entitled “Wavelength Conversion Component With Scattering Particles”, which is hereby incorporated by reference in its entirety.

A cavity is formed in the space between the LEDs 24 and the phosphor layer 36, which is hereby referred to herein as a “mixing chamber”. The volume of the mixing chamber is large enough to permit the LED 24 to be located, wholly or partially, within the interior of the mixing chamber. A benefit provided by this arrangement is that the chamber provides for mixing of light within highly transparent solid with minimal loss. An example of this occurs when a lamp includes both red and blue LEDs in the chamber, and the chamber allows the light from these LEDs (e.g., the red light) to be uniformly distributed.

There are various reasons for the advantages provided by the internal mixing chamber. For example, one reason is because the arrangement of the internal mixing chamber provides for cross-wall emissions of light. Even though a light reflective surface 28 are still provided on the “floor” of the lighting arrangement, much of the light that moves through the mixing chamber will cross from one wall of the phosphor to another wall without needing to reflect from the reflectors, improving the efficiency of the lamp for its light production. Another benefit provided by the arrangement is that it removes the point source impact of having individual LEDs in the lighting arrangement. Each LED is a point source of light (e.g., blue or red light), but because the LEDs are within the chamber that has its walls covered with phosphor, the light emitted by the phosphor will visibly obscure the point source effects of the LEDs. Yet another advantage is the directionality provided by the current arrangement. Since the inventive lighting arrangement 10 will likely be inserted into ceiling or wall fixtures, it is likely that the emitted light will be provided in a desired direction, e.g., away from the ceiling or wall. The present embodiment of using the lens and internal chamber configuration enhances the directionality of the emitted light in the desired directions. Another benefit provided by embodiments of the invention is that the amount of phosphor needed to manufacture the lamp can be minimized for a given size of the lighting arrangement. Even though the external dimensions of the lighting arrangement may be quite large due to the size of the lens, the smaller surface area of the internal chamber means that a much smaller amount of phosphor is actually required for the lighting arrangement. A further benefit of the small internal chamber is that it reduces the apparent size of the phosphor component 36 when viewing the lighting arrangement in an OFF-state.

Each of the LEDs 24 may be covered or otherwise encapsulated or the mixing chamber 42 filled with a light extracting cover/encapsulant 44. The light extracting cover 44 reduces the mismatch between the index of refraction of the LEDs 24 and the index of refraction of the air within the interior mixing chamber 42 between the LEDs 24 and the phosphor layer 36. Any mismatch in the indices of refraction can cause a significant portion of the LED light to be lost from the total LED light output. By including light extracting cover 42, this helps to reduce excessive mismatches in the indices of refraction, facilitating an increase the overall light conversion efficiency of lighting arrangement 10.

In some embodiments, the light diffuser portion 34 in direct contact with photoluminescence material region 36 within the integrated wavelength conversion component 12. The mean refractive index of the light diffuser portion 34 and photoluminescence regions 36 is approximately 1.4 to 1.55 in some embodiments. The refractive indices of the two regions 34 and 36 preferably match within 0.2, where the refractive index of polymer materials that can be used is in the in typical range 1.35 to 1.6 in some embodiments.

Assume that the surface area of the exterior light emitting surface of the light diffusive portion 34 is represented as SA₁ mm². Further assume that the total exterior light emitting surface area of photoluminescence regions 36 is represented as SA₂ mm² (e.g., the area that is in contact with the diffuser portion). To ensure good OFF-State white appearance SA₁ is at least three times the amount of SA₂, and is preferably at least five times the amount in some embodiments. The minimum distance t between the exterior of the phosphor region 36 and exterior surface of diffuser portion 34 (shown in FIG. 3D) is at least 3 mm, where the minimum is typically at least 5 mm in some embodiments.

The overall diameter of the integrated wavelength conversion component 12 is preferably greater about 25 mm, and more typically is greater than about 50 mm. The depth of the integrated wavelength conversion component 12 can be configured to be in the range from 5-20 mm in some embodiments. In one embodiment, the integrated wavelength conversion component 12 has a diameter of approximately 76 mm (3 inches) and a depth of approximately 12 mm (0.47 inches) with a surface area of the diffusing portion at 11,850 mm² and the surface area of the phosphor region at 4475 mm².

In one embodiment, the diffusion portion corresponds to the following:

Mass=40.11 grams

Volume=40109.31 cubic millimeters

Surface area=11851.31 square millimeters

In one embodiment, the phosphor portion corresponds to the following:

Mass=2.12 grams

Volume=2117.99 cubic millimeters

Surface area=4475.36 square millimeters

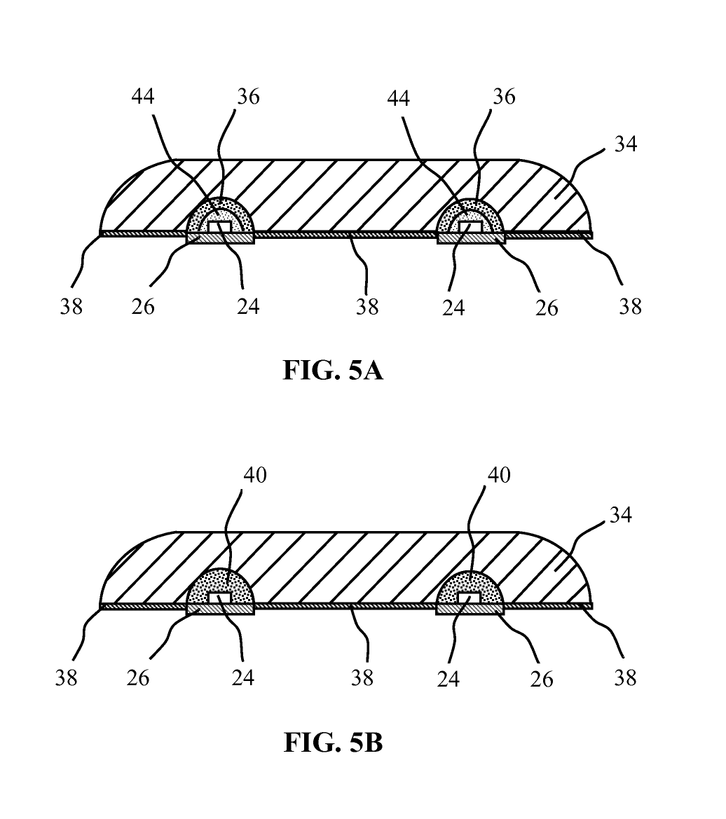

In some embodiments, as shown in FIG. 5A, further operating efficiencies for the arrangement 10 are provided by filling the mixing chamber 42 with an optical medium 44. The optical medium 44 within the chamber comprises a material, e.g., a solid material, possessing an index of refraction that more closely matches the index of refraction for the phosphor 36, the LEDs 24, and/or any type of encapsulating material 44 that may exist on top of the LEDs 24. One reason for using the optical medium is to eliminate air interfaces that exist between the LEDs 24 and the phosphor 36. The problem addressed by this embodiment is that there is a mismatch between the index of refraction of the material of the phosphor 36 and the index of refraction of the air within the interior volume of the mixing chamber. This mismatch in the indices of refraction for the interfaces between air and the lamp components may cause a significant portion of the light to be lost. As a result, lesser amounts of light and excessive amounts of heat are generated for a given quantity of input power. By filling the mixing chamber with an optical medium 44, this approach permits light to be emitted to, within, and/or through the interior volume of the lamp without having to incur losses caused by excessive mismatches in the indices of refraction for an air interface. The optical medium may be selected of a material, e.g. silicone, to generally fall within or match the index of refraction for materials typically used for the phosphor 36, the LEDs 24, and/or any encapsulating material that be used to surround the LEDs 24. Further details regarding an exemplary approach to implement the optical medium are described in U.S. application Ser. No. 13/769,210, filed on Feb. 15, 2013, entitled “Solid-State Lamps With Improved Emission Efficiency And Photoluminescence Wavelength Conversion Components Therefor”, which is hereby incorporated by reference in its entirety.

As shown in FIG. 3D, the phosphor layer 36 is formed in the toroidal indentation in the top portion 34 of the integrated wavelength conversion component 12, where the phosphor layer comprises a cross-sectional profile having a shape that is dome-like, generally ellipsoidal, candle-like, and/or conical shape. Each of these shapes provides advantageous performance benefits under different circumstances. For example, the approach of using the dome-shaped cross-sectional profile provides a more uniform pattern in the near field (at or near the tube surface) light distribution and better far field beam control. The conical sectional shape provides a greater distribution of light along the sides of the lamp. In contrast, the dome-shaped sectional profile of provides a greater distribution of light towards the top of the lamp. This highlights the ability to shape the light produced by the lamp by configuring the shape of the sectional profile of the phosphor/chamber. The approach of using the dome-shaped cross-sectional profile generally corresponds to less phosphor surface area than the cone-shaped sectional profile.

The arrangement of the lamp can also be configured to improve its light producing efficiency (also referred to herein as “System Quantum Efficiency” or SQE) and to reduce SQE light loss, where system quantum efficiency can be defined as the ratio of the total number of photons produced by the system to the number of photons generated by the LED. Many white LEDs and LED arrays are typically constructed of blue LEDs encapsulated with a layer of silicone containing particles of a powdered phosphor material or covered using an optical component (optic) including the phosphor material. The system quantum efficiency (SQE) of the known white LED and LED arrays is negatively affected by the loss of the total light output of the lamp during conversion of the blue LED light to white light, where the majority of light loss is not due to the photoluminescence conversion process but rather due to absorption losses for light (both photoluminescence and LED light) that is emitted back into the LED(s). Due to the photoluminescence conversion process being isotropic, photoluminescence light will be emitted in all directions and hence up to about 50% will be generated in a direction back towards the LED(s) giving rise to re-absorption and loss of photoluminescence light by the LED(s). Therefore, by appropriately configuring the aspect ratio of the phosphor portion 36, it is possible to eliminate or significantly reduce the SQE losses of the lamp. The aspect ratio of the phosphor portion 36 is the ratio of the area of the phosphor layer to the area of the LED package.

According to some embodiments of the invention, SQE loss is significantly eliminated or reduced by implementing the following combination of factors:

i) remote phosphor—the phosphor portion is separated from the LEDs;

ii) a coupling optic—An optical material having a high refractive index material is coupled directly to LEDs and the phosphor conversion component. This material should have a refractive index of 1.4 or greater (>1.5 preferred). Good optical coupling between the blue LEDs and the clear optic is used to ensure that it effectively acts as a light transport layer. By eliminating air interfaces and refractive index mismatches, virtually all light generated by the LEDs will travel with virtually no or minimal loss to the wavelength conversion component (phosphor layer).

iii) phosphor wavelength conversion layer with an aspect ratio for the cross-sectional profile that is greater than 1:1—the phosphor layer is separated from the blue LEDs by the clear coupling optic. Ideally the outer phosphor optic is the same refractive index as the clear layer and has no gap or other optical loss in the interface to the clear optic. The phosphor outer layer optic has an aspect ratio of 1:1 or greater such that the total surface area of the outer phosphor layer in contact with the clear coupling optic is at least three times the area of the LED package surface coupled to the clear coupling optic.

In operation blue light travels through the clear coupling optic with effectively no loss. When the blue light excites the phosphor layer and the photoluminescence light can now travel equally in any direction due to the elimination of the optical medium/air interface. Due to the high aspect ratio of the photoluminescence wavelength conversion component a majority of light (both phosphor generated light and scattered LED light) will not travel back to the LED package. Instead most light will travel through the clear optic to the other side and exit out of the phosphor layer on the opposing side. Once converted, YGR (Yellow, Green, Red) light easily passes through the phosphor layer. In summary, the majority of light is no longer re-cycled directly between the phosphor and the package/LEDs as it is in standard LED configurations.

FIG. 5B illustrates an alternative embodiment. In this embodiment, the mixing chamber within indentation 42 is filled with a medium 40, where the medium 40 includes phosphor material. Unlike the approach of FIG. 5A, a separate layer of phosphor 36 is not used that is remote to the LEDs 24. Instead, the phosphor material is distributed within the medium 40 that surrounds the LEDs 24.

Both of the arrangements of FIGS. 5A and 5B result in a light engine in which the LEDs 24 are incorporated within the integrated wavelength conversion component. In particular, the LEDs 24 are positioned within the mixing chamber formed by toroidal indentation 42.

Referring to FIG. 3D there is shown a preferred method of fabricating the integrated component 12 in accordance with some embodiments of the invention. The top light diffusing portion 34 is provided having an indented portion 42 on its underside. A layer of phosphor 36 is deposited or otherwise injection molded into the indented portion 42. After the phosphor has been deposited, the top portion 34 can be affixed to the light reflective base 38.

Any suitable manufacturing process may be employed to manufacture the integrated wavelength conversion component 12. For example, a molding process can be used to form the light diffusive portion 34. The phosphor layer 36 can be formed using any suitable approach. For example, a spray coating or printing process can be employed where ink is coated directly within the surface of the indentation 42 in the underside of the light diffusive portion 34. Molding may also be used to mold the phosphor layer. Lamination can also be performed to manufacture the phosphor layer.

Numerous alternative configurations can be employed within the scope of the invention to implement the integrated wavelength conversion component 12, housing 14, and/or overall configuration of the lamp 10. For example, the above-described embodiments disclose an integrated wavelength conversion component 12 where the phosphor 36 is incorporated in a single toroidal indentation 42 that forms a circular profile that matches the circular shape of the integrated wavelength conversion component 12. However, the invention is also applicable to implement an integrated wavelength conversion component 12 that has a different configuration for the number, shape or orientation of the indentation 42 and/or phosphor layer 36.

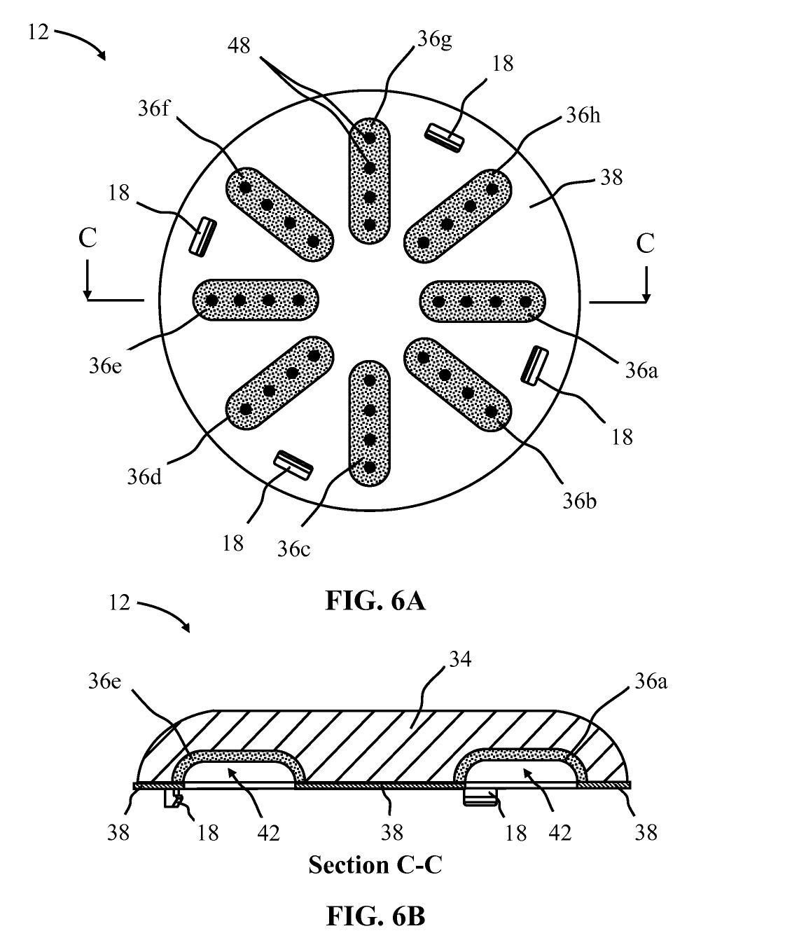

FIGS. 6A and 6B illustrate an alternative form of integrated wavelength conversion component 12 having a plurality (e.g., eight) of photoluminescence wavelength conversion regions 36a to 3h in which each region extends in a radial direction similar to spokes of a wheel. Each of the regions 36a to 3h comprises an indentation 42 having a layer of phosphor deposited therein. The photoluminescence wavelength conversion regions 36a to 3h overlays a respective LED array. Within FIG. 6A, solid dots 48 indicate the location of the LEDs 24.

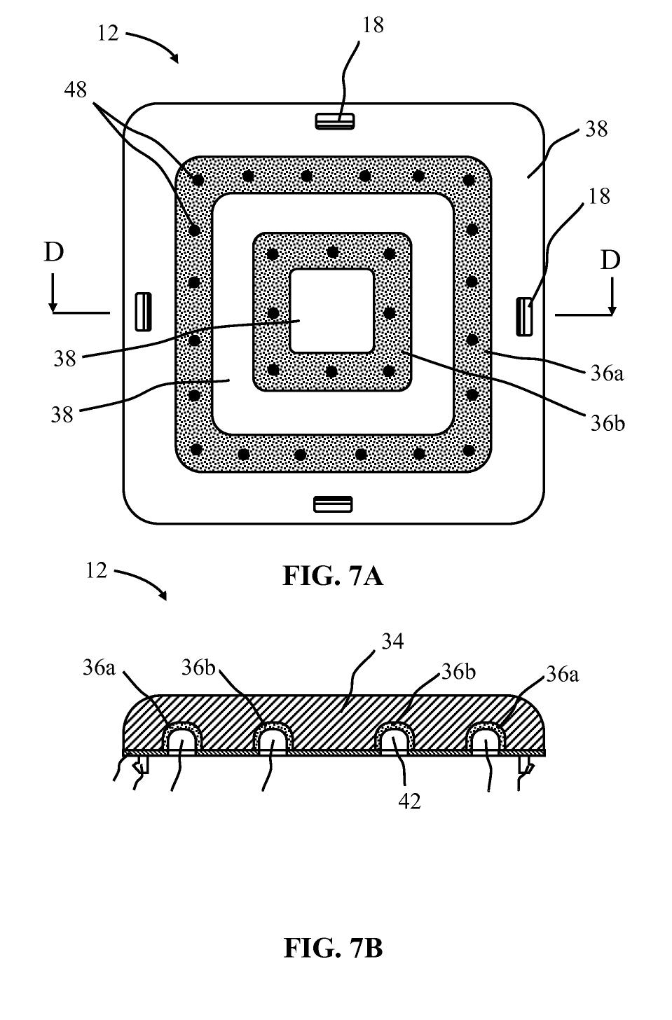

FIGS. 7A and 7B illustrate an alternative form for the integrated wavelength conversion component 12. In this embodiment, the integrated wavelength conversion component 12 includes multiple (e.g., two) concentric photoluminescence wavelength conversion regions 36a and 36b. As noted above, the photoluminescence wavelength conversion regions do not need to be circular in shape. Here, the photoluminescence wavelength conversion regions 36a and 36b within integrated wavelength conversion component 12 are shaped to be generally square in shape, and are concentric such that one is smaller and located within the boundaries of the other. Each of the regions 36a and 36b overlays a respective LED array. Within FIG. 7A, the solid dots 48 indicate the location of the LEDs 24.

It will be appreciated that the invention is not limited to the exemplary embodiments described and that variations can be made within the scope of the invention.

What is claimed is:

1. A lighting apparatus, comprising:
an integrated wavelength conversion component comprising a light diffusive portion and a wavelength conversion portion, wherein the light diffusive portion comprises a diffusing material and the wavelength conversion portion comprises a photoluminescent material;
a housing for the integrated wavelength conversion component; and
wherein the integrated wavelength conversion component functions as a final stage optic for the lighting apparatus.

2. The apparatus of claim 1, wherein the housing comprises a shallow depression to house the integrated wavelength conversion component.

3. The apparatus of claim 2, wherein the housing comprises a central recessed portion and the integrated wavelength conversion component is placed into the central recessed portion.

4. The apparatus of claim 1, wherein the integrated wavelength conversion component comprises a generally toroidal indentation, and the wavelength conversion portion is formed in the indentation.

5. The apparatus of claim 4, wherein the wavelength conversion portion comprises a generally semi-circular, generally elliptical or dome-shaped cross-sectional profile.

6. The apparatus of claim 4, wherein the housing comprises a circuit board having an array of solid-state light emitters, and the array of solid-state light emitters matches the toroidal indentation.

7. The apparatus of claim 1, wherein the diffusing portion having the diffusing material is positioned at the exterior of the integrated wavelength conversion component.

8. The apparatus of claim 8, wherein the diffusing material is distributed within the diffusing portion.

9. The apparatus of claim 1, further comprising an optical medium within a cavity formed between the wavelength conversion portion and an array of solid state light emitters.

10. The apparatus of claim 1, wherein the housing has a dish-shaped recess and a bezel.

11. The apparatus of claim 1, wherein the integrated wavelength conversion component comprises a base having mounting clips.

12. The apparatus of claim 1, wherein the integrated wavelength conversion component is integrally formed with the base having the mounting clips.

13. The apparatus of claim 1, wherein the diffusing portion and the wavelength conversion portion are molded into the integrated wavelength conversion component.

14. The apparatus of claim 1, wherein the wavelength conversion portion is remote from an array of solid-state light emitters.

15. The apparatus of claim 1, wherein the wavelength conversion portion comprises multiple wavelength conversion regions.

16. The apparatus of claim 15, in which the multiple wavelength conversion regions extends in a radial direction.

17. The apparatus of claim 15, in which the multiple wavelength conversion regions comprise concentric regions.

18. The apparatus of claim 17, in which the concentric regions comprise concentric rectangular regions.
